(19) United States
(12) Patent Application Publication
(10) Pub. No.: US 2025/0198943 A1
(43) Pub. Date: Jun. 19, 2025

(54) SHEET MATERIAL EDGE BURR DETECTION DEVICE

(71) Applicant: SUPERSONIC ARTIFICIAL INTELLIGENCE TECHNOLOGY CO., LTD, Guangzhou (CN)

(72) Inventors: Junfeng ZHANG, Guangzhou (CN); Shidui WANG, Guangzhou (CN); Changchun YE, Guangzhou (CN); Fuping LI, Guangzhou (CN)

(21) Appl. No.: 19/069,652

(22) Filed: Mar. 4, 2025

Related U.S. Application Data
(63) Continuation of application No. PCT/CN2023/092901, filed on May 9, 2023.

(30) Foreign Application Priority Data
Feb. 27, 2023 (CN) 202320346618.8

(51) Int. Cl. G01N 21/93; G01N 21/88

(52) U.S. Cl. CPC G01N 21/93; G01N 21/8806; G01N 2021/8841; G01N 2201/021

(57) ABSTRACT

Disclosed is a sheet material edge burr detection device, comprises a base, a detection table, a fixing apparatus, a visual detection apparatus, a flanging driving apparatus and a detection driving apparatus; wherein the detection table is arranged on the base and is configured to place a sheet material; the fixing apparatus is configured to fix the sheet material on the detection table; the visual detection apparatus is arranged on the base and located on one side of the detection table in a width direction, and is configured to acquire an appearance image of a long-side edge of the sheet material on the detection table, wherein the long-side edge is close to the visual detection apparatus; the flanging driving apparatus is configured to drive the detection table to rotate, thereby switching the sheet material on the detection table to be close to the long side of the visual detection apparatus.

### CROSS REFERENCE TO RELATED APPLICATIONS

The present application is a continuation of International (PCT) Patent Application No. PCT/CN2023/092901, filed on May 9, 2023, which claims the priority of Chinese patent application No. 202320346618.8, filed on Feb. 27, 2023, and the entire contents of which are hereby incorporated by reference in their entireties.

### TECHNICAL FIELD

The present disclosure relates to detection devices, and in particular to a sheet material edge burr detection device.

### BACKGROUND

At present, materials are prone to producing burrs after edges are cut off, thereby affecting the quality of the materials, for example, when a pole piece produces burrs after its edge is cut off, if the length of the burrs exceeds the standard, an isolation film will be punctured, thereby resulting in a short circuit of positive and negative electrodes of a battery and lowering the yield rate of lithium batteries; therefore, a visual detection apparatus is adopted now for burr detection of the sheet materials, as mentioned in the existing literature with an application number of 201711418611.8 (the title of the application is Sheet Material Burr Visual Detection Apparatus), wherein a first visual detection mechanism and a second visual detection mechanism are adopted to acquire appearance images of edges of both sides of the sheet material, respectively, so as to achieve burr detection, and the single-sided visual detection mechanism is low in utilization rate.

### SUMMARY

In order to overcome deficiencies of the prior art, the objective of the present disclosure is to provide a sheet material edge burr detection device, and such sheet material edge burr detection device can improve the utilization rate of the visual detection apparatus.

The objective of the present disclosure is achieved using the following technical solutions.

A sheet material edge burr detection device includes:

a base;

a detection table arranged on the base and configured to place a sheet material;

a fixing apparatus configured to fix the sheet material on the detection table;

a visual detection apparatus arranged on the base and located on one side of the detection table in a width direction, and the visual detection apparatus is configured to acquire an appearance image of a long-side edge of the sheet material on the detection table, wherein the long-side edge is close to the visual detection apparatus;

a flanging driving apparatus, wherein the detection table is arranged to be rotatable; and the flanging driving apparatus is configured to drive the detection table to rotate, thereby switching the sheet material on the detection table to be close to the long side of the visual detection apparatus; and

a detection driving apparatus, wherein the detection table or the visual detection apparatus is arranged to move along a length direction of the detection table; and the detection driving apparatus is configured to drive the visual detection apparatus or the detection table to move along the length direction of the detection table.

Further, the fixing apparatus includes a plurality of adsorption holes formed on the detection table.

Further, the detection table includes a locking apparatus and two detection pallets; the two detection pallets is arranged to be close to or away from each other, and the two detection pallets are respectively configured to cooperate with two opposite sides in a width direction of the sheet material; the detection pallets are formed with the adsorption holes; and the locking apparatus is configured to fix the detection pallets onto the base.

Further, the sheet material edge burr detection device further comprises a clutch driving apparatus, wherein the detection table or the visual detection apparatus is arranged to move along a width direction of the detection table; and the clutch driving apparatus is configured to drive the detection table or the visual detection apparatus to move along the width direction of the detection table.

Further, the sheet material edge burr detection device further comprises a deviation correcting apparatus, wherein the deviation correcting apparatus includes a deviation correcting plate and a deviation correction driving apparatus, the deviation correcting plate is located on one side of the detection table in the width direction and is parallel to the length direction of the detection table; the deviation correcting plate is arranged on the base, and the deviation correcting plate is arranged to further move along the width direction of the detection table and is configured to abut against one side of the sheet material on the detection table; and the deviation correction driving apparatus is configured to drive the deviation correcting plate to move.

Further, the visual detection apparatus includes a first visual detection assembly, the first visual detection assembly includes a first camera, a first light source assembly and a reflecting prism; the first camera is arranged vertically; the first light source assembly is configured to emit light in a transverse direction to the sheet material; and the reflecting prism is configured to reflect the light reflected transversely by the sheet material to the first camera.

Further, the visual detection apparatus further includes a second visual detection assembly, and the second visual detection assembly includes a second camera and a second light source assembly; the second camera is arranged to face downwards; and the second light source assembly is located below the second camera, and the second light source assembly emits lights towards an upward direction.

Further, the visual detection apparatus further includes a housing; and the first visual detection assembly and the second visual detection assembly are both arranged within the housing.

Further, a front face of the housing is recessed to form a U-shaped detection channel, the U-shaped detection channel is recessed inside the housing, and the U-shaped detection channel is arranged to allow the sheet material to pass through; an upper wall of the U-shaped detection channel is formed with a shooting opening, and a lower wall of the U-shaped detection channel is formed with a light outlet; the second light source assembly is located below the light outlet, and the second light source assembly emits light towards the light outlet; and the second camera is located above the shooting opening and faces towards the shooting opening.

Further, an inner wall of a back face of the housing is formed with a detection opening, and the detection opening corresponds to the U-shaped detection channel; the first light source assembly emits light towards the detection opening; and the reflecting prism has a reflecting surface, and the reflecting surface faces towards the detection opening and the first camera.

Compared with the prior art, the present disclosure has the following beneficial effects:

in the present disclosure, a sheet material is fixed onto a detection table through a fixing apparatus, and after a visual detection apparatus acquires an appearance image of a long-side edge of the sheet material on the detection table, where the long-side edge is close to the visual detection apparatus, the visual detection apparatus cooperates with the flanging driving apparatus to drive the detection table to rotate, thereby driving the sheet material to rotate, and further switching the sheet material to be close to the long side of the visual detection apparatus, and then, the visual detection apparatus acquires the appearance image of the edge of the other long side of the sheet material, therefore, the visual detection apparatus is configured to acquire the appearance image of edges of both sides of the sheet material, and has a high utilization rate.

### BRIEF DESCRIPTION OF THE DRAWINGS

FIG. 1 is a structural schematic diagram of the sheet material edge burr detection device of the present disclosure;

FIG. 2 is a structural schematic diagram of the flanging driving apparatus, the detection table and the deviation correcting apparatus of the present disclosure;

FIG. 3 is a structural schematic diagram of the visual detection apparatus of the present disclosure;

FIG. 4 is a schematic diagram of the internal structure of the visual detection apparatus of the present disclosure;

FIG. 5 is a structural schematic diagram of the visual detection apparatus of the present disclosure (with the housing being removed).

Reference numerals in the figures: 10. base; 20. detection table; 21. detection pallet; 22. locking apparatus; 30. fixing apparatus; 31. adsorption hole; 40. visual detection apparatus; 41. first visual detection assembly; 411. first camera; 412. first light source assembly; 413. reflecting prism; 4131. reflecting surface; 42. second visual detection assembly; 421. second camera; 422. second light source assembly; 43. housing; 431. detection opening; 432. light outlet; 433. shooting opening; 434. front face of the housing; 435. back face of the housing; 436. U-shaped detection channel; 50. flanging driving apparatus; 60. detection driving apparatus; 70. deviation correcting apparatus; 71. deviation correcting plate; 72. deviation correction driving apparatus; 80. clutch driving apparatus; 90. sheet material.

### DETAILED DESCRIPTION OF THE EMBODIMENTS

The technical solutions in the embodiments of the present application will be clearly and completely described below in combination with the accompanying drawings in the embodiments of the present application. Obviously, the described embodiments are only a part rather than all of the embodiments of the present application. Based on the embodiments in the present application, all the other embodiments obtained by those skilled in the art without any creative effort fall within the scope of protection of the present application.

In the description of the present application, it should be noted that, unless otherwise expressly specified and limited, the terms “installation”, “connected” and “connection” should be understood in a broad sense, e.g., the “connection” may be a fixed connection, a detachable connection, or an integral connection; it may be a mechanical connection or an electrical connection; it may be a direct connection or an indirect connection through an intermediate medium; it may also be a connection between two elements. For those skilled in the art, the specific meanings of the above terms in the present application may be understood according to specific conditions.

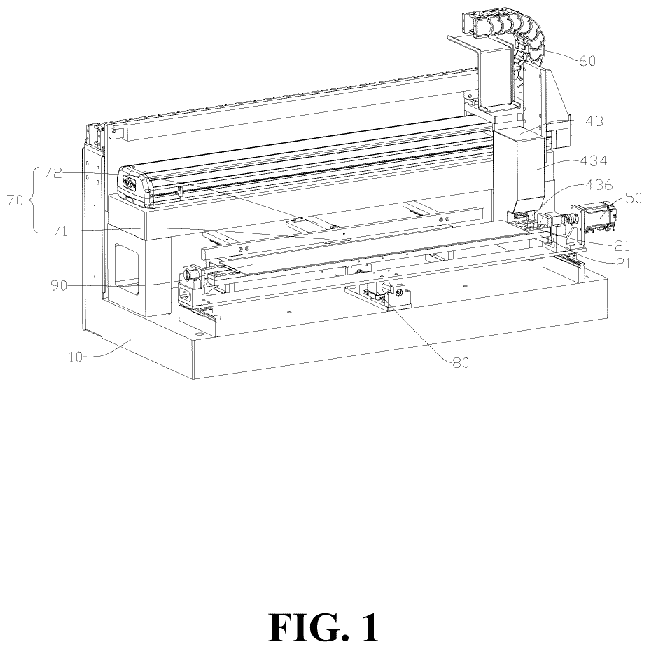

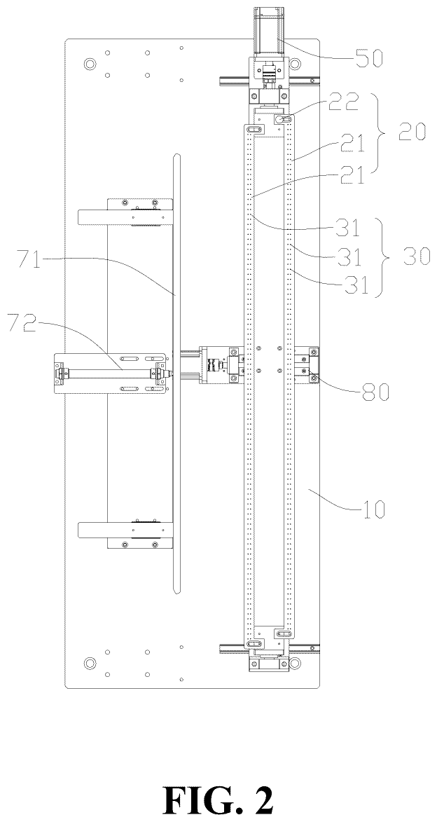

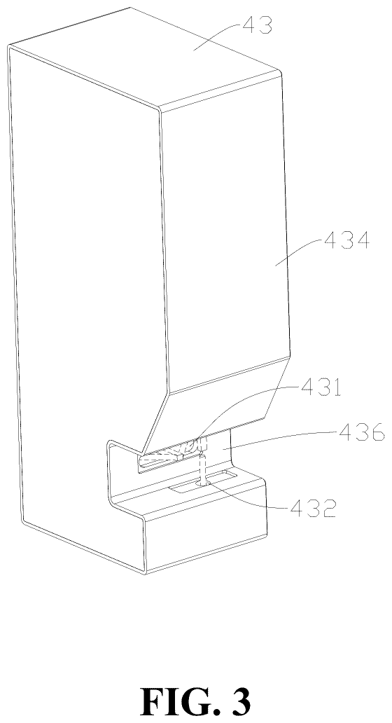

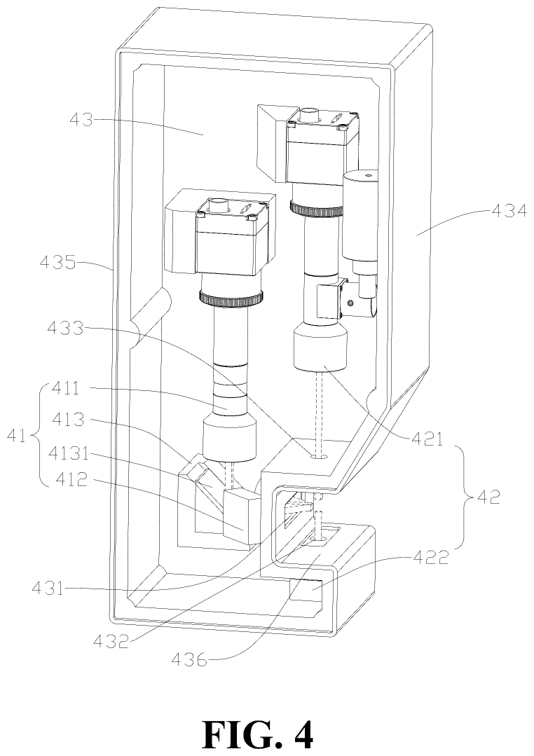

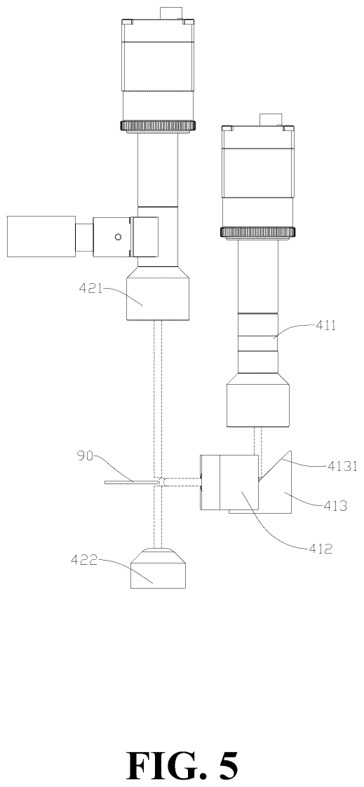

Referring to FIG. 1 to FIG. 5, the present disclosure discloses a sheet material edge burr detection device, including a base 10, a detection table 20, a fixing apparatus 30, a visual detection apparatus 40, a flanging driving apparatus 50, and a detection driving apparatus 60; wherein the detection table 20 is arranged on the base 10 and is configured to place a sheet material 90; the fixing apparatus 30 is configured to fix the sheet material 90 on the detection table 20; the visual detection apparatus 40 is arranged on the base 10 and located on one side of the detection table 20 in a width direction, and is configured to acquire an appearance image of a long-side edge of the sheet material 90 on the detection table 20, wherein the long-side edge is close to the visual detection apparatus 40; the detection table 20 is arranged to be rotatable; the flanging driving apparatus 50 is configured to drive the detection table 20 to rotate, thereby switching the sheet material 90 on the detection table 20 to be close to the long side of the visual detection apparatus 40; one of the detection table 20 or the visual detection apparatus 40 is arranged to move along a length direction of the detection table 20; and the detection driving apparatus 60 is configured to drive the visual detection apparatus 40 or the detection table 20 to move along the length direction of the detection table 20.

On the basis of the above structure, when in use, the fixing apparatus 30 fixes the sheet material 90 onto the detection table 20, and the long side of the sheet material 90 extends out of the detection table 20, at this time, one of the long sides of the sheet material 90 is close to the visual detection apparatus 40, and the visual detection apparatus 40 acquires an appearance image of the edge of one of the long sides of the sheet material 90, and the detection driving apparatus 60 drives the detection table 20 or the visual detection apparatus 40 to move, adjusts relative positions of the sheet material 90 and the visual detection apparatus 40, to obtain the appearance image of the overall edge of one of the long sides of the sheet material 90; afterwards, the flanging driving apparatus 50 is adopted to drive the detection table 20 to rotate, the sheet material 90 rotates along with the detection table 20, while the other long side of the sheet material 90 is adjusted to be close to the visual detection apparatus 40, and through cooperation between the visual detection apparatus 40 and the detection driving apparatus 60, the appearance image of the overall edge of the other long side of the sheet material 90 is obtained; therefore, a single-sided visual detection apparatus 40 is adopted to acquire the appearance image of the edges of both sides of the sheet material 90, and the utilization rate is high.

It is worth mentioning that when an appearance image of the edge of a long side of the sheet material 90 is acquired by the visual detection apparatus 40, whether the sheet material 90 has burrs and/or the length of the burrs can be known, so as to realize burr detection of the sheet material 90, and the detection principle can be known from the prior art, and will not be repeated redundantly herein.

The above detection driving apparatus 60 may adopt an existing cylinder and drive belt driving apparatus and the like.

The fixing apparatus 30 of this embodiment includes a plurality of adsorption holes 31 formed on the detection table 20, at this time, a negative pressure is formed in the adsorption holes 31 to adsorb and fix the sheet material 90, with little damage to the sheet material 90.

In order to expand the application scope of this sheet material edge burr detection device, the detection table 20 of this embodiment includes a locking apparatus 22 and two detection pallets 21; the two detection pallets 21 is arranged to be close to or away from each other and correspond to two opposite sides of the sheet material 90 on a width direction, and the two detection pallets 21 are configured to cooperate with the two opposite sides of the sheet material 90 in the width direction; each of the detection pallets 21 is formed with an adsorption hole 31; and the locking apparatus 22 is configured to fix each detection pallet 21 onto the base 10; at this time, the distance between the two detection pallets 21 is adjusted, and then the locking apparatus 22 is used to fix each detection pallet 21, therefore, the two detection pallets 21 can correspond to the sheet materials 90 of different width sizes, so as to adsorb and fix the part, close to the edge, of the sheet materials 90 of different width sizes through the adsorption holes 31, thereby preventing the sheet material 90 from shaking due to its softness and thinness, and further the sheet material edge burr detection device is applied to detection of the sheet materials 90 of different width sizes.

The above locking apparatus 22 may adopt, but is not limited to, a locking screw.

In order that the edges of the long sides of the sheet materials 90 of different width sizes can be aligned with the visual detection apparatus 40, this embodiment further includes a clutch driving apparatus 80, and one of the detection table 20 or the visual detection apparatus 40 can also move along a width direction of the detection table 20; the clutch driving apparatus 80 is configured to drive the detection table 20 or the visual detection apparatus 40 to move along the width direction of the detection table 20; it can be understood that when the detection table 20 can move, the clutch apparatus is configured to drive the detection table 20; in this way, after the sheet material 90 is fixed onto the detection table 20, the detection table 20 or the visual detection apparatus 40 is moved by an actual width of the sheet material 90, such that the sheet material 90 moves in the width direction relative to the visual detection apparatus 40, and the long side of the sheet material 90 is aligned with the visual detection apparatus 40.

The above clutch driving apparatus 80 may adopt but is not limited to a structure in which a linear cylinder, a motor and a drive belt cooperate with each other.

In other embodiments, the flanging driving apparatus 50 is configured to drive the detection table 20 to rotate around a vertical axis of the detection table 20, and at this time, the detection table 20 requires a circular area with its length as the diameter for rotation, and requires a large space; the flanging driving apparatus 50 of this embodiment is configured to drive the detection table 20 to rotate around an axis that is parallel to the length direction of the detection table 20, in this way, the detection table 20 requires a circular area with its width as the diameter for rotation, thereby saving the required space.

After the sheet material 90 is placed on the detection table 20, leftward and rightward offset may occur. Therefore, this embodiment further includes a deviation correcting apparatus 70, wherein the deviation correcting apparatus 70 includes a deviation correcting plate 71 and a deviation correction driving apparatus 72, and the deviation correcting plate 71 is located on one side of the detection table 20 in the width direction and is parallel to the length direction of the detection table 20; the deviation correcting plate 71 is arranged on the base 10, and the deviation correcting plate 71 is arranged to further move along the width direction of the detection table 20 and is configured to abut against one side of the sheet material 90 on the detection table 20; and the deviation correction driving apparatus 72 is configured to drive the deviation correcting plate 71 to move; when in use, one side of the sheet material 90 abuts against the deviation correcting plate 71, and the sheet material 90 can be adjusted, such that when the sheet material 90 and the visual detection apparatus 40 move relative to each other, the visual detection apparatus 40 can be aligned with each position on the long side of the sheet material 90, thereby ensuring detection accuracy of the sheet material 90.

The visual detection apparatus 40 of this embodiment includes a first visual detection assembly 41, the first visual detection assembly 41 includes a first camera 411, a first light source assembly 412 and a reflecting prism 413; the first camera 411 is arranged vertically; the first light source assembly 412 is configured to emit light in a transverse direction to the sheet material 90; and the reflecting prism 413 is configured to reflect the light transversely reflected by the sheet material 90 to the first camera 411; in this way, the first light source assembly 412 emits transverse light, the sheet material 90 reflects light, and the reflecting prism 413 reflects light to the first camera 411, such that the vertically arranged first camera 411 can acquire an appearance image of the edge of the sheet material 90 along a transverse direction, so as to detect longitudinal burrs on an edge of the long side of the sheet material 90; the above first camera 411 is vertically arranged to fully use the vertical space and save a transverse space, thereby conforming to the current development direction of arranging along a vertical space.

The visual detection apparatus 40 of this embodiment further includes a second visual detection assembly 42, the second visual detection assembly 42 includes a second camera 421 and a second light source assembly 422; the second camera 421 is arranged to face downwards; the second light source assembly 422 is located below the second camera 421, and the second light source assembly 422 emits light towards an upward direction; in this way, after the second light source assembly 422 emits light towards the sheet material 90, after the second camera 421 photographs the sheet material 90, i.e., the second camera 421 acquires an appearance image of the edge of the long side of the sheet material 90 along a vertical direction, and can detect transverse burrs on the edge of a long side of the sheet material 90.

The visual detection apparatus 40 of this embodiment further includes a housing 43, and the first visual detection assembly 41 and the second visual detection assembly 42 are both arranged within the housing 43, thereby protecting the first visual detection assembly 41 and the second visual detection assembly 42 from being influenced by external impacts and other factors, and avoiding mechanical damages due to external factors.

A front face 434 of the housing in this embodiment is recessed to form a U-shaped detection channel 436, the U-shaped detection channel 436 is recessed inside the housing 43, the U-shaped detection channel 436 is arranged to allow the sheet material 90 to pass through; an upper wall of the U-shaped detection channel 436 is formed with a shooting opening 433, and a lower wall of the U-shaped detection channel 436 is formed with a light outlet 432; the second light source assembly 422 is located below the light outlet 432, and the second light source assembly 422 emits light towards the light outlet 432; and the second camera 421 is located above the shooting opening 433 and faces towards the shooting opening 433. Therefore, since the U-shaped detection channel 436 is recessed inside the housing 43, the shooting opening 433 and the light outlet 432 are also recessed inside the housing 43, such that the second camera 421 and the second light source assembly 422 within the housing 43 are vertically aligned with the shooting opening 433 and the light outlet 432, respectively.

In this embodiment, an inner wall of a back face 435 of the housing is formed with a detection opening 431, and the detection opening 431 corresponds to the U-shaped detection channel 436; the first light source assembly 412 emits light towards the detection opening 431; the reflecting prism 413 has a reflecting surface 4131, and the reflecting surface 4131 faces towards the detection opening 431 and the first camera 411; in this way, the reflecting prism 413 can receive the light reflected from the sheet material 90 through the detection opening 431 and reflect the light to the first camera 411; in this way, the shooting opening 433 can be arranged vertically by utilizing an upper wall of the U-shaped detection channel 436, the light outlet 432 can be arranged vertically by utilizing a lower wall of the U-shaped detection channel 436, and the detection opening 431 can be transversely arranged by utilizing an inner wall of the back face 435 of the housing corresponding to the U-shaped detection channel 436. The structure is simple and easy to implement.

It is worth mentioning that the above front face 434 of the housing and the back face 435 of the housing are oppositely arranged faces.

The above embodiments are merely preferred embodiments of the present disclosure, and cannot be used to limit the scope of protection of the present disclosure, and any non-substantial changes and substitutions made by those skilled in the art on the basis of the present disclosure fall within the scope of protection claimed by the present disclosure.

What is claimed is:

1. A sheet material edge burr detection device, comprising:
a base;
a detection table arranged on the base and configured to place a sheet material;
a fixing apparatus configured to fix the sheet material on the detection table;
a visual detection apparatus arranged on the base and located on one side of the detection table in a width direction, and the visual detection apparatus is configured to acquire an appearance image of a long-side edge of the sheet material on the detection table, wherein the long-side edge is close to the visual detection apparatus;
a flanging driving apparatus, wherein the detection table is arranged to be rotatable; the flanging driving apparatus is configured to drive the detection table to rotate, thereby switching the sheet material on the detection table to be close to the long side of the visual detection apparatus; and
a detection driving apparatus, wherein the detection table or the visual detection apparatus is arranged to move along a length direction of the detection table; and the detection driving apparatus is configured to drive the visual detection apparatus or the detection table to move along the length direction of the detection table.

2. The sheet material edge burr detection device according to claim 1, wherein the fixing apparatus comprises a plurality of adsorption holes formed on the detection table.

3. The sheet material edge burr detection device according to claim 2, wherein the detection table comprises a locking apparatus and two detection pallets; the two detection pallets is arranged to be close to or away from each other, and the two detection pallets are respectively configured to cooperate with two opposite sides of the sheet material in a width direction; the detection pallets are formed with the adsorption holes; and the locking apparatus is configured to fix the detection pallets onto the base.

4. The sheet material edge burr detection device according to claim 3, further comprising a clutch driving apparatus, wherein the detection table or the visual detection apparatus is arranged to move along a width direction of the detection table; and the clutch driving apparatus is configured to drive the detection table or the visual detection apparatus to move along the width direction of the detection table.

5. The sheet material edge burr detection device according to claim 1, further comprising a deviation correcting apparatus, wherein the deviation correcting apparatus comprises a deviation correcting plate and a deviation correction driving apparatus, the deviation correcting plate is located on one side of the detection table in the width direction and is parallel to the length direction of the detection table; the deviation correcting plate is arranged on the base, the deviation correcting plate is arranged to further move along the width direction of the detection table and is configured to abut against one side of the sheet material on the detection table; and the deviation correction driving apparatus is configured to drive the deviation correcting plate to move.

6. The sheet material edge burr detection device according to claim 1, wherein the visual detection apparatus comprises a first visual detection assembly, the first visual detection assembly comprises a first camera, a first light source assembly and a reflecting prism; the first camera is arranged vertically; the first light source assembly is configured to emit light in a transverse direction to the sheet material; and the reflecting prism is configured to reflect the light reflected transversely by the sheet material to the first camera.

7. The sheet material edge burr detection device according to claim 6, wherein the visual detection apparatus further comprises a second visual detection assembly, the second visual detection assembly comprises a second camera and a second light source assembly; the second camera is arranged to face downwards; and the second light source assembly is located below the second camera, and the second light source assembly emits lights towards an upward direction.

8. The sheet material edge burr detection device according to claim 7, wherein the visual detection apparatus further comprises a housing; and the first visual detection assembly and the second visual detection assembly are both arranged within the housing.

9. The sheet material edge burr detection device according to claim 8, wherein a front face of the housing is recessed to form a U-shaped detection channel, the U-shaped detection channel is recessed inside the housing, and the U-shaped detection channel is arranged to allow the sheet material to pass through; an upper wall of the U-shaped detection channel is formed with a shooting opening, and a lower wall of the U-shaped detection channel is formed with a light outlet; the second light source assembly is located below the light outlet, and the second light source assembly emits light towards the light outlet; and the second camera is located above the shooting opening and faces towards the shooting opening.

10. The sheet material edge burr detection device according to claim 9, wherein an inner wall of a back face of the housing is formed with a detection opening, and the detection opening corresponds to the U-shaped detection channel; the first light source assembly emits light towards the detection opening; and the reflecting prism has a reflecting surface, and the reflecting surface faces towards the detection opening and the first camera.
